(19) United States
(12) Patent Application Publication
(10) Pub. No.: US 2022/0326865 A1
(43) Pub. Date: Oct. 13, 2022

(54) QUALITY OF SERVICE (QoS) BASED DATA DEDUPLICATION

(71) Applicant: EMC IP Holding Company LLC, Hopkinton, MA (US)

(72) Inventors: Ramesh Doddaiah, Westborough, MA (US); Malak Alshawabkeh, Franklin, MA (US)

(73) Assignee: EMC IP Holding Company LLC, Hopkinton, MA (US)

(21) Appl. No.: 17/227,627

(22) Filed: Apr. 12, 2021

(51) Int. Cl. G06F 3/06

(52) U.S. Cl. CPC G06F 3/0641; G06F 3/0611; G06F 3/0613; G06F 3/0653; G06F 3/0679

(57) ABSTRACT

Aspects of the present disclosure relate to data deduplication (dedupe). In embodiments, an input/output operation (IO) stream is received by a storage array. In addition, a received IO sequence in the IO stream that matches a previously received IO sequence is identified. Further, a data deduplication (dedupe) technique is performed based on a selected data dedupe policy. The data dedupe policy can be selected based on a comparison of service quality (QoS) related to the received IO sequence and a QoS related to the previously received IO sequence.

### BACKGROUND

A storage array is a data storage system for block-based storage, file-based storage, or object storage. Rather than store data on a server, storage arrays use multiple drives in a collection capable of storing a vast amount of data. Storage arrays can include a central management system that manages the data. Storage arrays can establish data dedupe techniques to maximize the capacity of their storage drives. Data deduplication techniques eliminate redundant data in a data set. The methods can include identifying copies of the same data and deleting the copies such that only one copy remains.

### SUMMARY

Aspects of the present disclosure relate to data deduplication (dedupe). In embodiments, an input/output operation (IO) stream is received by a storage array. A received IO sequence in the IO stream that matches a previously received IO sequence is identified. Further, a data deduplication (dedupe) technique is performed based on a selected data dedupe policy. The data dedupe policy can be selected based on comparing the quality of service (QoS) related to the received IO sequence and a QoS related to the previously received IO sequence.

In embodiments, the QoS can correspond to one or more of each IO's service level and/or a performance capability of each IO's related storage track.

In embodiments, a unique fingerprint for the received IO stream can be generated. Further, the received IO stream's unique fingerprint can be matched to the previously received IO sequence's fingerprint. The fingerprints can be matched by querying a searchable data structure that correlates one or more fingerprints with respective one or more previously received IO sequences.

In embodiments, a storage track related to each IO of the received IO sequence can be identified. Additionally, a fingerprint for the received IO sequence can be generated based on each specified storage track's address space.

In embodiments, a QoS corresponding to each identified address space can be identified. A QoS corresponding to each address space related to the previously received IO sequence can also be determined. Further, each QoS related to the received IO sequence can be with each QoS related to the previously received IO sequence.

In embodiments, all possible QoS relationships resulting from the comparison can be determined. Further, one or more data dedupe policies can be established based on each possible QoS relationship.

In embodiments, one or more IO workloads the storage array is expected to receive can be predicted. One or more data dedupe policies can be established based on the possible QoS relationships and/or at least one characteristic related to the one or more predicted IO workloads. A QoS mismatch data dedupe policy can also be established based on the received IO sequence and the previously received IO sequence having a mismatched QoS relationship, wherein the mismatched QoS relationship indicates that the storage tracks related to the received IO sequence have higher or lower performance capabilities than the storage tracks related to the previously received IO sequence.

In embodiments, a QoS mixed data dedupe policy can further be established based on the received IO sequence and the previously received IO sequence having respective IOs with matching and mismatched QoS relationships.

In embodiments, each of the QoS matching data dedupe policy, QOS mismatch data dedupe policy, and QoS mixed data dedupe policy can be established based further on one or more of: a) a QoS device identifier associated with each storage track's related storage device, b), a QoS group identifier associated with each storage track's related storage group and/or c) a QoS group identifier associated with each storage track's related storage group.

### BRIEF DESCRIPTION OF THE DRAWINGS

The preceding and other objects, features, and advantages will be apparent from the following more particular description of the embodiments, as illustrated in the accompanying drawings. Like reference characters refer to the same parts throughout the different views. The drawings are not necessarily to scale, emphasis instead being placed upon illustrating the embodiments' principles.

FIG. 1 is a block diagram of a storage array in accordance with embodiments of the present disclosure.

FIG. 2 is a block diagram of a dedupe controller in accordance with embodiments of the present disclosure.

FIG. 3 is a block diagram of a dedupe processor in accordance with embodiments of the present disclosure.

FIG. 4 is a flow diagram of a method for data dedupe in accordance with embodiments of the present disclosure.

### DETAILED DESCRIPTION

A storage array uses a central management system to store data using various storage media types (e.g., memory and storage drives). Each type of storage media can have different characteristics. The characteristics can relate to the storage media's cost, performance, capacity, and the like. Accordingly, the central management system can establish a tiered storage architecture. For example, the management system can group the storage media into one or more storage tiers based on each media's capacity, cost, and performance characteristics. In response to the array receiving an input/output operation (IO), the management system can assign data related to the IO to a storage tier based on the data's business value. For example, a host provides a service level (SL) indication with the IO. The service level can define an expected array performance (e.g., response time) for processing the IO. As such, the tiered storage architecture can assign data to a storage tier based on the SL.

In some circumstances, the array can receive an IO with a write data request. The data related to the request can be associated with a first storage tier. A data dedupe process can identify matching data previously stored in one or more tracks of a second storage tier. As such, rather than writing the data to the first storage tier, the dedupe process could identify the data as duplicate data. The dedupe process can further discard the data to preserve the array's storage capacity. However, a future IO may require an array performance tied to the first storage tier's unique characteristics. Thus, the storage array may not meet the expected performance of the future IO.

As discussed in greater detail herein, the present disclosure's embodiments relate to techniques that dedupe IOs based on their respective QoS requirements.

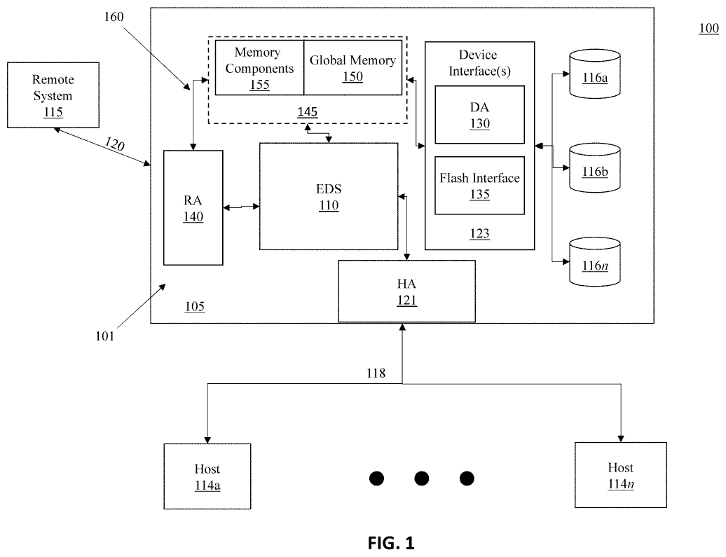

Referring to FIG. 1, a system 100 includes a storage array 105 that includes components 101 configured to perform one or more distributed file storage services. In embodiments, the array 105 can include one or more internal communication channels 160 that communicatively couple each of the array's components 101. The communication channels 160 can include Fibre channels, internal busses, and/or communication modules. For example, the array's global memory 150 can use the communication channels 160 to transfer data and/or send other communications between the array's components 101.

In embodiments, the array 105 and one or more devices can form a network. For example, a first communication medium 118 can communicatively couple the array 105 to one or more host systems 114a-n. Likewise, a second communication medium 120 can communicatively couple the array 105 to a remote system 115. The first and second mediums 118, 120 can interconnect devices to form a network (networked devices). The network can be a wide area network (WAN) (e.g., Internet), local area network (LAN), intranet, Storage Area Network (SAN)), and the like.

In further embodiments, the array 105 and other networked devices (e.g., the hosts 114a-n and the remote system 115) can send/receive information (e.g., data) using a communications protocol. The communications protocol can include a Remote Direct Memory Access (RDMA), TCP, IP, TCP/IP protocol, SCSI, Fibre Channel, Remote Direct Memory Access (RDMA) over Converged Ethernet (ROCE) protocol, Internet Small Computer Systems Interface (iSCSI) protocol, NVMe-over-fabrics protocol (e.g., NVMe-over-ROCEv2 and NVMe-over-TCP), and the like.

The array 105, remote system 116, hosts 115a-n, and the like can connect to the first and/or second mediums 118,120 via a wired/wireless network connection interface, bus, data link, and the like. Further, the first and second mediums 118, 120 can also include communication nodes that enable the networked devices to establish communication sessions. For example, communication nodes can include switching equipment, phone lines, repeaters, multiplexers, satellites, and the like.

In embodiments, one or more of the array's components 101 can process input/output (IO) workloads. An IO workload can include one or more IO requests (e.g., operations) originating from one or more of the hosts 114a-n. The hosts 114a-n and the array 105 can be physically co-located or located remotely from one another. In embodiments, an IO request can include a read/write request. For example, an application executing on one of the hosts 114a-n can perform a read or write operation resulting in one or more data requests to the array 105. The IO workload can correspond to IO requests received by the array 105 over a time interval.

In embodiments, the array 105 and remote system 115 can include any one of a variety of proprietary or commercially available single or multi-processor systems (e.g., an Intel-based processor and the like). Likewise, the array's components 101 (e.g., HA 121, RA 140, device interface 123, and the like) can include physical/virtual computing resources (e.g., a processor and memory) or require access to the array's resources. The memory can be a local memory 145 configured to store code that the processor can execute to perform one or more storage array operations.

In embodiments, the HA 121 can be a Fibre Channel Adapter (FA) that manages communications and data requests between the array 105 and any networked device (e.g., the hosts 114a-n). For example, the HA 121 can direct one or more IOs to one or more of the array's components 101 for further storage processing. In embodiments, the HA 121 can direct an IO request to the array's device interface 123. The device interface 123 can manage the IO request's read/write data operation requiring access to the array's data storage devices 116a-n. For example, the data storage interface 123 can include a device adapter (DA) 130 (e.g., storage device controller), flash drive interface 135, and the like that controls access to the storage devices 116a-n. Likewise, the array's Enginuity Data Services (EDS) processor 110 can manage access to the array's local memory 145.

In embodiments, the array's storage devices 116a-n can include one or more data storage types, each having distinct performance capabilities. For example, the storage devices 116a-n can include a hard disk drive (HDD), solid-state drive (SSD), and the like. Likewise, the array's local memory 145 can include global memory 150 and memory components 155 (e.g., register memory, shared memory constant memory, user-defined memory, and the like). The array's memory 145 can include primary memory (e.g., memory components 155) and cache memory (e.g., global memory 150). The primary memory and cache memory can be volatile and/or nonvolatile memory. Unlike nonvolatile memory, volatile memory requires power to store data. Thus, volatile memory loses its stored data if the array 105 loses power for any reason. In embodiments, the primary memory can include dynamic (RAM) and the like, while cache memory can include static RAM and the like. Like the array's storage devices 116a-n, the array's memory 145 can have different storage performance capabilities.

In embodiments, a service level agreement (SLA) can define at least one Service Level Objective (SLO) the hosts 114a-n expect the array 105 to achieve. For example, the hosts 115a-n can include host-operated applications. The host-operated applications can generate data for the array 105 to store and/or read data the array 105 stores. The hosts 114a-n can assign different levels of business importance to data types they generate or read. As such, each SLO can define a service level (SL) for each data type the hosts 114a-n write to and/or read from the array 105. Further, each SL can define the host's expected storage performance requirements (e.g., a response time and uptime) for one or more data types.

Accordingly, the array's EDS 110 can establish a storage/memory hierarchy based on one or more of the SLA and the array's storage/memory performance capabilities. For example, the EDS 110 can establish the hierarchy to include one or more tiers (e.g., subsets of the array's storage/memory) with similar performance capabilities (e.g., response times and uptimes). Thus, the EDS-established fast memory/storage tiers can service host-identified critical and valuable data (e.g., Platinum, Diamond, and Gold SLs), while slow memory/storage tiers service host-identified non-critical and less valuable data (e.g., Silver and Bronze SLs).

In embodiments, the HA 121 can present the hosts 114a-n with logical representations of the array's physical storage devices 116a-n and memory 145 rather than giving their respective physical address spaces. For example, the EDS 110 can establish at least one logical unit number (LUN) representing a slice or portion of a configured set of disks (e.g., storage devices 116a-n). The array 105 can present one or more LUNs to the hosts 114a-n. For example, each LUN can relate to at least one physical address space of storage. Further, the array 105 can mount (e.g., group) one or more LUNs to define at least one logical storage device (e.g., logical volume (LV)).

In further embodiments, the HA 121 can receive an IO request that identifies one or more of the array's storage tracks. Accordingly, the HA 121 can parse that information from the IO request to route the request's related data to its target storage track. In other examples, the array 105 may not have previously associated a storage track to the IO request's related data. The array's DA 130 can assign at least one storage track to service the IO request's related data in such circumstances. In embodiments, the DA 130 can assign each storage track with a unique track identifier (TID). Accordingly, each TID can correspond to one or more physical storage address spaces of the array's storage devices 116a-n and/or global memory 145. The HA 121 can store a searchable data structure that identifies the relationships between each LUN, LV, TID, and/or physical address space. For example, a LUN can correspond to a portion of a storage track, while an LV can correspond to one or more LUNs and a TID corresponds to an entire storage track.

In embodiments, the array's RA 140 can manage communications between the array 105 and an external storage system (e.g., remote system 115) over, e.g., a second communication medium 120 using a communications protocol. In embodiments, the first medium 118 and/or second medium 120 can be an Explicit Congestion Notification (ECN) Enabled Ethernet network.

In embodiments, the array's EDS 110 can perform one or more self-optimizing techniques (e.g., one or more machine learning techniques) to deliver performance, availability, and data integrity services for the array 105 and its components 101. For example, the EDS 110 can perform a data deduplication technique in response to identifying a write IO sequence that matches a previously received write IO sequence. In some circumstances, the identified IO sequence's related data can correspond to the array's first storage tier. However, the previous workload's matching IO sequence can be associated with the array's second storage tier. As discussed in greater detail herein, the EDS 110 can perform data dedupe techniques in response to identifying an IO write sequence based on the sequence's QoS requirements.

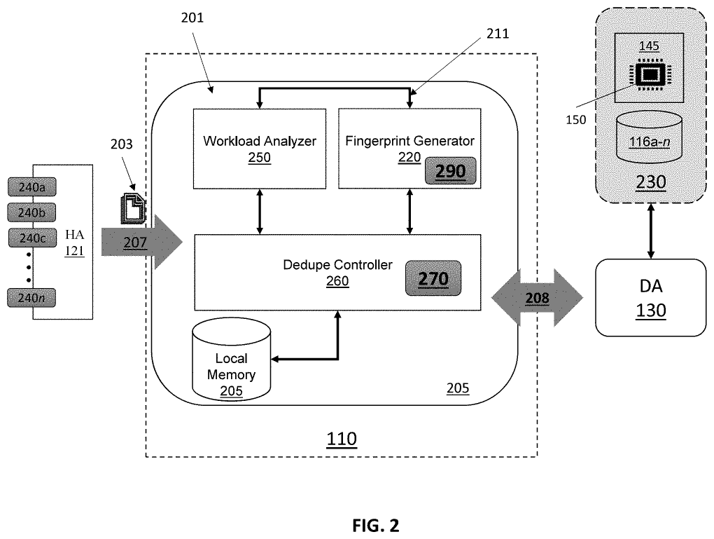

Regarding FIG. 2, the EDS 110 can include a data dedupe processor 205. The processor 205 can include one or more elements 201 configured to perform at least one data dedupe technique. In embodiments, one or more of the dedupe processor's elements 205 can reside in one or more of the array's other components 101. Further, the dedupe processor 110 and its elements 201 (e.g., software and hardware elements) can be any type of commercially available processor, such as an Intel-based processor and the like. Additionally, the dedupe processor 205 can include one or more internal communication channels 211 that communicatively couple each of the processor's elements 201. The communication channels 211 can include Fibre channels, internal busses, and/or communication modules.

In response to receiving an IO workload 207, the dedupe processor 205 can provide data deduplication services to optimize the array's storage capacity (e.g., efficiently control utilization of storage resources). In embodiments, the processor 205 can perform one or more dedupe operations that reduce the impact of redundant data on storage costs. For example, a first host (e.g., host 114a) may issue a sequence of IO write requests (e.g., sequence 203) for the array 105 to store an email with attachments. Accordingly, the email and its attachments can require one or more portions of the array's storage resources 230 (e.g., disks 116a-n and/or memory 150). In this example, the first host received the email from a second host (e.g., 114b). However, the array 105 can have previously stored the email and its attachments in response to receiving a similar IO request from the second host. Using a QoS-based data deduplication technique, the data dedupe processor 205 can perform QoS data dedupe as described in greater detail in the following paragraphs.

In embodiments, the processor 110 can identify sequential write IO patterns across multiple tracks and store that information in local memory 205 (e.g., in a portion of a track identifier's (TID's) persistent memory region). For example, the processor 110 can identify each sequential write IO pattern's dynamic temporal behavior described in greater detail herein. Further, the processor 110 can determine an empirical distribution mean of successful rolling offsets from tracks related to the sequential write IO pattern. In embodiments, the processor 110 can determine the empirical distribution mean from a first set of sample IOs of the sequential write IO pattern. Using the empirical distribution mean, the processor 110 can locate to find an optimal (e.g., statistically relevant) rolling offset of the sequential write IO pattern. With such a technique, the present disclosure's embodiments can advantageously reduce the need to generate large quantities of fingerprints per track. As such, the embodiments can further significantly reduce the consumption of the array's storage resources.

In embodiments, the processor 110 can include a fingerprint generator 220 that generates a dedupe fingerprint for each data track related to each IO. Additionally, the generator 220 can store the fingerprints in one or more data structures (e.g., hash tables) that associate the fingerprints with their respective data tracks. Further, the generator 220 can link related data tracks. For example, if a source Track A's fingerprint matches with target track B's fingerprint, the generator 220 can link them as similar data blocks in the hash table. Accordingly, the generator 220 can improve disk storage efficiency by eliminating a need to store multiple references to related tracks.

In embodiments, the fingerprint generator 220 can segment the data involved with a current IO into one or more data portions. Each segmented data portion can correspond to a size of one or more of the data tracks of the devices 116a-n. For each segmented data portion, the generator 220 can generate a data segment fingerprint. Additionally, the generator 220 can generate data track fingerprints representing each identified track from the current IO's metadata. For example, each IO can include one or more LVs and/or logical unit numbers (LUNs) representing the data tracks allocated to provide storage services for the IO's related data. The fingerprints can have a data format optimized (e.g., having characteristics) for search operations. As such, the fingerprint generator 220 can use a hash function to generate a fixed-sized identifier (e.g., fingerprint) from each track's data and each segmented data portion. Thereby, the fingerprint generator 220 can restrict searches to fingerprints having a specific length to increase search performances (e.g., speed). Additionally, the generator 30 can determine fingerprint sizes that reduce the probability of distinct data portions having the same fingerprint. Using such fingerprints, the processor 110 can advantageously consume a minimal amount of the array's processing (e.g., CPU) resources to perform a search.

In embodiments, the processor 110 can include a workload analyzer 250 communicatively coupled to the HA 121 via a communications interface. The interface can include, e.g., a Fibre Channel and NVMe (Non-Volatile Memory Express) Channel. The analyzer 250 can receive storage telemetry data corresponding to the array and/or its components 100 from the EDS processor 110 of FIG. 1. For example, the analyzer 250 can include logic and/or circuitry configured to analyze the one or more IO workload 207 received by the HA 121. The analysis can include identifying one or more characteristics of each IO of the workload 207. For example, each IO can include metadata including information associated with an IO type, data track related to the data involved with each IO, time, performance metrics, and telemetry data, and the like. Based on historical and/or current IO characteristic data, the analyzer 250 can identify IO patterns using, e.g., one or more machine learning (ML) techniques. Using the identified IO patterns, the analyzer 250 can determine whether the array 105 is experiencing an intensive IO workload. The analyzer 250 can identify the IO workload 207 as intensive if it includes one or more periods during with the array 105 receives a large volume of IOs per second (IOPS). For any IO associated with an intensive workload, the analyzer 250 can indicate the association in the IO's metadata.

In embodiments, the processor 110 can also include a dedupe controller 260 that can perform one or more data deduplication techniques in response to receiving an IO write request. Further, the controller 260 can pause data deduplication operations based on a state of the array 105. For example, the controller 260 can perform an array performance check in response to receiving an IO associated with an intensive IO workload. If the array performance check indicates that the array 105 is not meeting at least one performance expectation of one or more of the hosts 114a-n, the controller 260 can halt dedupe operations. In other examples, the controller 260 can proceed with performing dedupe operations if an IO is not associated with an intensive workload and/or the array meets performance expectations and can continue to do so should the controller 260 continue to perform dedupe operations.

If the current IOs are related to the previously allocated data tracks, the dedupe controller 260 can compare one or more portions of the write data and corresponding one or more portions of data previously stored in the previously allocated data tracks using their respective fingerprints. Current naïve data deduplication techniques perform a byte to byte (i.e., brute force) comparison of each fingerprint and disk data. However, such techniques can consume a significant and/or unnecessary amount of the array's resources (e.g., the array's disk bandwidth, fabric bandwidth, CPU cycles for comparison, memory, and the like). Accordingly, such naïve dedupe techniques can cause the array 105 to fail to meet one or more of the hosts' 114a-n performance expectations during peak workloads (e.g., intensive workloads). To avoid such scenarios, the controller 260 can limit a comparison search to a subset of the segmented data fingerprints and a corresponding subset of the data track fingerprints.

Based on the number of matching fingerprints, the controller 260 can identify a probability of whether the data involved with the current IO is a duplicate of data previously stored in the array 105. If the probability is above a threshold, the controller 260 can discard the data. If the probability is less than the threshold, the controller 260 can write the data to the data tracks of the devices 16a-n.

In further embodiments, the controller 260 can dedupe misaligned matching IO write sequences based on their respective track lengths. For example, if the matching IO write sequences have track lengths less than a threshold, the controller 260 can perform a dynamic chunk dedupe operation to remove redundant data. If the track lengths are longer than the threshold, the controller 260 can perform a dedupe operation using a dynamic temporal-based deduplication technique described in greater detail herein.

For example, the controller 260 can identify sequential write IO patterns across multiple tracks based on the identified patterns. Further, the controller 260 can and store that information in local memory 205. For example, when a host 114a-n IO sequence includes requests to write data across multiple tracks, a probability of the sequence's related data (or blocks or tracks) with a statistical correlation is relatively high and exhibits a high temporal relationship. The controller 260 can detect such a sequential IO stream. First, for example, the controller 260 can check a SCSI logical block count (LBC) size of each IO and/or bulk read each previous track's TID. In other examples, the controller 260 can use sequential write IO identification techniques that include analyzing sequential track allocations, sequential zero reclaim, sequential read IO prefetches to identify sequential write IOs (e.g., sequential write extents). Second, the controller 260 can also search cache tracks for recently executed write operations during a time threshold (e.g., over a several millisecond time window). Third, the controller 260 can mark bits related to the recently executed write operations related to a sequential write IO pattern. For example, the controller 260 can mark one or more bits of a track's TID to identify an IO's relationship to a sequential write IO pattern. In an embodiment, the controller 260 can establish one of each track's TID as a sequential IO bit, and another bit as a sequential IO checked bit.

Further, the controller 260 can identify a temporal relationship and a level of relative correlation between IOs in a sequential write IO pattern. Based on the temporal relationship and relative correlation level, the controller 260 can determine a probability of receiving a matching sequence having rolling offsets across multiple tracks.

In embodiments, the dedupe controller 260 can include a QoS dedupe processor 270. As described in greater detail in the following paragraphs, the dedupe processor 270 can further perform data dedupe based on a relationship of matching IO write sequences' associated track sequence QoS.

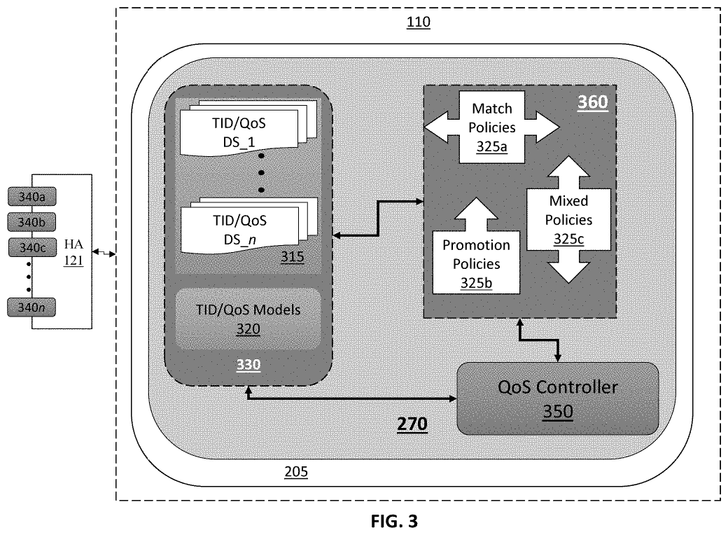

Regarding FIG. 3, the array's HA 121 can include ports 340a-n, each having a unique port identifier (PI) that interfaces with the medium 118. The analyzer 250 can map each port's identifier to one or more of the hosts 114a-n and/or host-operated applications. The analyzer 250 can characterize IO requests issued by each host's operated application. For example, a predetermined service level agreement (SLA) can define each of the host-operated applications and their corresponding SLs. Accordingly, the analyzer 250 can predetermine possible IO characteristics. The analyzer 250 can store a PI searchable data structure that identifies any relationships between the host's port, an application, IO characteristics, TIDs, and the like in the processor's local memory 205.

In response to receiving an IO request, the HA 121 can identify the port that received the request and add its corresponding port identifier to the IO request's metadata. In other embodiments, the hosts 114a-n and/or the host-operated applications can add the HA's port identifier to an IO request's metadata and/or relevant protocol layer (e.g., a transport layer) in response to generating the IO request. The hosts 114a-n and host application can add the identifier when the hosts 114a-n or host application generates IO request's metadata and/or relevant protocol layer.

In embodiments, the QoS processor 270 can include a QoS analyzer 330 that characterizes each IO write sequence's request. For example, the QoS analyzer 330 can extract the host's port identifier from each IO request. Further, the QoS analyzer 330 can characterize the IO sequence, as a whole, by analyzing each IO sequence's write requests. The characteristics can include a service level (SL), performance expectation, track-level and/or application-level quality of service (QoS), IO size, IO type, and the like. Additionally, the analyzer 330 can identify one or more TIDs related to each IO request. Further, QoS analyzer 330 can generate a searchable storage QoS data structure 315. The storage QoS data structure 315 defines one or more relationships between a storage track, TID, and assigned track/application QoS, and the like (e.g., TID/QoS entries DS_1-n).

In embodiments, the array 105 can receive a first IO write sequence with a previously received workload. The first IO write sequence can include IO requests with a first set of TIDs. The first set of TID's can correspond to physical address spaces assigned to a high-performance storage tier and thus, service higher SL IO requests. During a current IO workload, the dedupe processor 205 can identify a second IO write sequence matching the first IO write sequence using one or more of the dedupe techniques described herein. The QoS analyzer 330 can also determine whether the second sequence's related physical address spaces correspond to one or more storage tiers with lower, matching, and/or higher performance capabilities. Thus, the address spaces service corresponding lower, matching, and/or higher SL IO requests.

In embodiments, the QoS processor 270 can include a QoS manager 360 that includes one or more QoS-based dedupe policies 325a-c. In embodiments, the QoS manager 360 can include storage QoS demotion policies, promotion policies, and static policies 325a-c. The QoS manager 360 can predefine the policies 325a-c based on the array's configuration and a storage vendor-client service level agreement (SLA). For example, the manager 360 can read the array's config file that defines its configuration. Additionally, the manager 360 can parse anticipated IO workload information and characteristics from the SLA. In embodiments, the policies 325a-c can include instructions that the QoS controller 350 can execute to perform QoS updates.

In embodiments, the QoS processor 270 can include a QoS controller 350 that can identify patterns related to matching IO sequence storage tier relationships. Further, the QoS controller 350 can correlate the matching storage tier relationship patterns with IO workload patterns identified by the workload analyzer 250. For example, the QoS controller can use, e.g., a machine learning (ML) engine configured to perform, e.g., one or more self-learning techniques such as a recursive learning technique. The ML engine can use one or more of the self-learning techniques to identify the matching IO sequence storage tier patterns and their corresponding correlations with IO workload patterns. Based on the ML engine's output, the QoS controller 350 can dynamically generate QoS policies 325a-c that consider QoS relationships between the array's storage resources and current and/or anticipated IO workloads.

The following paragraphs describe example policies that one or more of the embodiments described herein can use. Further, the following paragraphs describe a non-limiting set of example policies. As such, a skilled artisan understands this disclosure contemplates any storage-related QoS policy relevant to performing one or more data dedupe techniques according to the example embodiments disclosed herein.

### QoS Matching Track Policy Example

Regarding this first policy example, the QoS processor 270 can establish a deduplication relationship using a match policy 325a. For example, the processor 270 can identify a dedupe relationship when QoS across source tracks (e.g., a previously received IO sequence's related tracks) and target tracks (e.g., a current IO sequence's related tracks) match. For example, a long write sequence can correspond to source tracks S1, S2, and S3. The source tracks can be associated with a first QoS requirement. The target tracks can be associated with a second QoS requirement. In response to identifying that the first and second QoS requirements are similar, the QoS processor 270 dedupe the IO sequence's data related to the source track. In embodiments, the QoS processor 270 can identify QoS requirements as similar if, e.g., a difference between the first and second QoS requirements is less than a QoS threshold. For example, if the QoS threshold is zero (0), the QoS controller 350 only performs data dedupe if, e.g., source tracks S1, S2, and S3 and target tracks T1, T2, and T3 have the same QoS (e.g., a Diamond QoS).

### QoS Promotion Example

Regarding this second policy example, the QoS processor 270 can identify a deduplication relationship even if the source and target tracks have different QoS requirements using a promotion policy 325a. For example, the processor 270 can receive instructions to identify a promotion dedupe relationship if a promotion condition is satisfied. For example, the promotion condition can be satisfied if the target tracks' performance capabilities are less than the source tracks' performance capabilities but better than a performance threshold. In response to identifying tracks meeting the condition, the QoS processor 270 can update the target track's TIDs to reference one or more of the array's storage resources (e.g., resources 230 of FIG. 2) that have performance capabilities similar to the source tracks' performance capabilities.

In embodiments, the source tracks S1, S2, and S3 can have performance capabilities that fulfill Diamond QoS service level requirements. However, the target tracks T1, T2, and T3 can have slower performance capabilities that can only fulfill, e.g., Bronze service level requirements. If the promotion threshold has unit values defined by SL steps and the threshold is defined as at most one lower step (e.g., −1), the target tracks would have a delta step value of −2. Thus, the processor 270 would not identify a dedupe relationship. However, if the tracks can fulfill Silver QoS service level requirements, they would have a delta step value of −1 and satisfy the promotion deduplication relationship requirement. Accordingly, the QoS processor 270 can then relocate the target tracks with performance capabilities to tracks that match the source track's capabilities.

### Mixed QoS Policy Example

Regarding this fourth policy example, the QoS processor 270 can use a mixed QoS policy 325c to identify a deduplication relationship between source tracks and target tracks. For example, source tracks can have a mixture of performance capabilities. As such, the array's response times would be inconsistent. In embodiments, the QoS policy 325c can have instructions that enable QoS processor 270 to perform dedupe while the array 105 is achieving response times less than a maximum response time threshold. Accordingly, the QoS processor 270 can identify a dedupe relationship between source tracks and target tracks when they have different QoS performances across each of their tracks despite causing the array to achieve varying response times.

### Storage Level QoS Policy Example

Regarding this fifth policy example, the QoS processor 270 can enable one or more of the array's storage resources (e.g., resources 230 of FIG. 2) to relocate their respective data to higher performance storage tracks. For example, the QoS processor can provide the array's storage resources having performance capabilities greater than a performance threshold with a data upgrade label. Accordingly, the array's data dedupe techniques can include determining if one of the array's storage resources includes the label to determine if a set of source tracks and a corresponding set of target tracks have a dedupe relationship. In other embodiments, the QoS processor 270 can generate a data upgrade searchable data structure that maps each resource with a data upgrade eligibility status. Accordingly, the processor 270 can selectively choose only a set of storage resources to balance data reduction and long sequential read response times.

### Storage Group QoS Policy Example

Regarding this sixth policy example, the QoS processor 270 can enable one or more of the array's storage groups (e.g., a logical volume (LV)) to relocate their respective data to higher performance storage group tracks. For example, the QoS processor 270 can receive instructions from one or more of the policies 325a-c to provide the array's storage groups having performance capabilities greater than a performance threshold with a data upgrade label. Accordingly, the array's data dedupe techniques can include determining if one of the array's storage groups includes the label to determine if a set of source tracks and a corresponding set of target tracks have a dedupe relationship. In other embodiments, the QoS processor 270 can generate a data upgrade searchable data structure that maps each storage group with a data upgrade eligibility status. Accordingly, the processor 270 can selectively choose a set of storage groups to balance data reduction and long sequential read response times. For instance, the QoS processor 270 can use one or more workload models to anticipate workloads that consume large quantities of the array's storage and processing resources. In response to receiving such a prediction, the QoS processor 270

### Data Dedupe Threshold QoS Policy Example

Regarding this seventh policy example, the QoS processor 270 can receive instructions from one of the policies 325a-c that limit a dedupe frequency of one or more of the array's storage resources (e.g., resources 230) or storage groups to be below a dedupe threshold. For example, the array 105 can receive workloads that consume an unanticipated amount of the array's storage and processing resources. Accordingly, the array 105 can be required to dedicate additional resources to process the workload's IO requests to meet service level requirements. By limiting specific storage resources and/or storage groups to a dedupe threshold amount of dedupe operations, the array 105 can ensure it has sufficient resources to handle the workload's IO requests.

In other embodiments, the QoS processor 270 can receive instructions from one of the policies 325a-c included a dedupe activation condition. For instance, the instructions can prevent one or more of the array's storage resources and storage groups from being involved in dedupe operations until the processor 270 has identified a match threshold amount of matching IO write sequences. Using such a policy can prevent the processor 270 from performing data dedupe for outlier matches (i.e., statistically irrelevant and infrequent).

Each drawing discussed in the following paragraphs describes a method and/or flow diagram in accordance with an aspect of the present disclosure. For simplicity of explanation, each method is depicted and described as a series of acts. However, acts in accordance with this disclosure can occur in various orders and/or concurrently and with other acts not presented and described herein. Furthermore, not all the illustrated acts may be required to implement their respective methods in accordance with the disclosed subject matter.

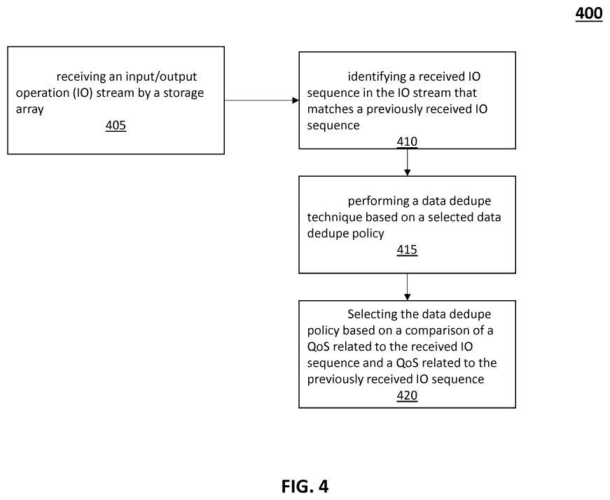

Regarding FIG. 4, a method 400 can be executed by, e.g., an array's EDS processor and/or any of the array's other components (e.g., the EDS processor 110 and/or the components 101 of FIG. 1). The method 400 describes steps for data deduplication (dedupe). At 405, the method 400 can include receiving an input/output operation (IO) stream by a storage array. The method 400, at 410, can also include identifying a received IO sequence in the IO stream that matches a previously received IO sequence. At 415, the method 400 can further include performing a data deduplication (dedupe) technique based on a selected data dedupe policy. The method 400, at 420, can also include selecting the data dedupe policy based on a comparison of quality of service (QoS) related to the received IO sequence and a QoS related to the previously received IO sequence. It should be noted that each step of the method 400 can include any combination of techniques implemented by the embodiments described herein.

Using the teachings disclosed herein, a skilled artisan can implement the above-described systems and methods in digital electronic circuitry, computer hardware, firmware, and/or software. The implementation can be as a computer program product. The implementation can, for example, be in a machine-readable storage device for execution by, or to control the operation of, data processing apparatus. The implementation can, for example, be a programmable processor, a computer, and/or multiple computers.

A computer program can be in any programming language, including compiled and/or interpreted languages. The computer program can have any deployed form, including a stand-alone program or as a subroutine, element, and/or other units suitable for a computing environment. One or more computers can execute a deployed computer program.

One or more programmable processors can perform the method steps by executing a computer program to perform functions of the concepts described herein by operating on input data and generating output. An apparatus can also perform the method steps. The apparatus can be a special purpose logic circuitry. For example, the circuitry is an FPGA (field-programmable gate array) and/or an ASIC (application-specific integrated circuit). Subroutines and software agents can refer to portions of the computer program, the processor, the special circuitry, software, and/or hardware that implement that functionality.

Processors suitable for the execution of a computer program include, by way of example, both general and special purpose microprocessors and any one or more processors of any digital computer. Generally, a processor receives instructions and data from a read-only memory or a random-access memory or both. For example, a computer's essential elements are a processor for executing instructions and one or more memory devices for storing instructions and data. Generally, a computer can include, can be operatively coupled to receive data from and/or transfer data to one or more mass storage devices for storing data (e.g., magnetic, magneto-optical disks, or optical disks).

Data transmission and instructions can also occur over a communications network. Information carriers suitable for embodying computer program instructions and data include all nonvolatile memory forms, including semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by and/or incorporated in special purpose logic circuitry.

A computer having a display device that enables user interaction can implement the above-described techniques. The display device can, for example, be a cathode ray tube (CRT) and/or a liquid crystal display (LCD) monitor. The interaction with a user can, for example, be a display of information to the user and a keyboard and a pointing device (e.g., a mouse or a trackball) by which the user can provide input to the computer (e.g., interact with a user interface element). Other kinds of devices can provide for interaction with a user. Other devices can, for example, be feedback provided to the user in any form of sensory feedback (e.g., visual feedback, auditory feedback, or tactile feedback). Input from the user can, for example, be in any form, including acoustic, speech, and/or tactile input.

A distributed computing system that includes a back-end component can also implement the above-described techniques. The back-end component can, for example, be a data server, a middleware component, and/or an application server. Further, a distributing computing system that includes a front-end component can implement the above-described techniques. The front-end component can, for example, be a client computer having a graphical user interface, a Web browser through which a user can interact with an example implementation, and/or other graphical user interfaces for a transmitting device. The system's components can interconnect using any form or medium of digital data communication (e.g., a communication network). Examples of communication networks include a local area network (LAN), a wide area network (WAN), the Internet, wired networks, and/or wireless networks.

The system can include clients and servers. A client and a server are generally remote from each other and typically interact through a communication network. A client and server relationship can arise by computer programs running on the respective computers and having a client-server relationship.

Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 networks, 802.116 networks, general packet radio service (GPRS) network, HiperLAN), and/or other packet-based networks. Circuit-based networks can include, for example, a public switched telephone network (PSTN), a private branch exchange (PBX), a wireless network, and/or other circuit-based networks. Wireless networks can include RAN, Bluetooth, code-division multiple access (CDMA) network, time division multiple access (TDMA) network, and global system for mobile communications (GSM) network.

The transmitting device can include, for example, a computer, a computer with a browser device, a telephone, an IP phone, a mobile device (e.g., cellular phone, personal digital assistant (P.D.A.) device, laptop computer, electronic mail device), and/or other communication devices. The browser device includes, for example, a computer (e.g., desktop computer, laptop computer) with a world wide web browser (e.g., Microsoft® Internet Explorer® and Mozilla®). The mobile computing device includes, for example, a Blackberry®.

Comprise, include, and/or, or plural forms of each are open-ended and include the listed parts and include additional elements that are not listed. And/or is open-ended and includes one or more of the listed parts and combinations of the listed features.

One skilled in the art will realize that other specific forms can embody the concepts described herein without departing from their spirit or essential characteristics. Therefore, the preceding embodiments are, in all respects, illustrative rather than limiting the concepts described herein. Scope of the concepts is thus indicated by the appended claims rather than by the preceding description. Therefore, all changes embrace the meaning and range of equivalency of the claims.

1. A method comprising:
receiving an input/output operation (IO) stream by a storage array;
identifying a received IO sequence in the IO stream that matches a previously received IO sequence; and
performing a data deduplication (dedupe) technique based on a selected data dedupe policy, wherein the data dedupe policy is selected based on a comparison of quality of service (QoS) related to the received IO sequence, a QoS related to the previously received IO sequence, and their respective IO data types.

2. The method of claim 1, wherein the QoS corresponds to one or more of each IO's service level and/or a performance capability of each IO's related storage track.

3. The method of claim 1, wherein identifying the matching previously received IO sequence includes:
generating a unique fingerprint for the received IO stream; and
matching the received IO stream's unique fingerprint to the previously received IO sequence's fingerprint, wherein matching fingerprints includes querying a searchable data structure that correlates one or more fingerprints with respective one or more previously received IO sequences.

4. The method of claim 1, further comprising:
identifying a storage track related to each IO of the received IO sequence; and
generating a fingerprint for the received IO sequence based on each identified storage track's address space.

5. The method of claim 3, further comprising:
identifying a QoS corresponding to each identified address space;
determining a QoS corresponding to each address space related to the previously received IO sequence; and
comparing each QoS related to the received IO sequence with each QoS related to the previously received IO sequence.

6. The method of claim 4, further comprising:
determining all possible QoS relationships resulting from the comparison; and
establishing one or more data dedupe policies based on each possible QoS relationship.

7. The method of claim 1, further comprising:
predicting one or more IO workloads the storage array is expected to receive; and
establishing the one or more data dedupe policies based on the possible QoS relationships and/or at least one characteristic related to the one or more predicted IO workloads.

8. The method of claim 4, further comprising:
establishing a QoS matching data dedupe policy based on the received IO sequence and the previously received IO sequence having a matching QoS relationship, wherein the matching QoS relationship indicates that the storage tracks related to the received IO sequence and the previously received IO sequence have substantially similar performance capabilities; and
establishing a QoS mismatch data dedupe policy based on the received IO sequence and the previously received IO sequence having a mismatched QoS relationship, wherein the mismatched QoS relationship indicates that the storage tracks related to the received IO sequence have higher or lower performance capabilities than the storage tracks related to the previously received IO sequence.

9. The method of claim 8, further comprising: establishing a QoS mixed data dedupe policy based on the received IO sequence and the previously received IO sequence having respective IOs with matching and mismatched QoS relationships.

10. The method of claim 9, further comprising:
establishing each of the QoS matching data dedupe policy, QOS mismatch data dedupe policy, and QoS mixed data dedupe policy-based further on one or more of:
a QoS device identifier associated with each storage track's related storage device,
a QoS group identifier associated with each storage track's related storage group, and/or
a threshold associated with the related storage devices and/or storage groups.

11. An apparatus including at least one processor configured to:
receive an input/output operation (IO) stream by a storage array;
identify a received IO sequence in the IO stream that matches a previously received IO sequence; and
perform a data deduplication (dedupe) technique based on a selected data dedupe policy, wherein the data dedupe policy is selected based on a comparison of quality of service (QoS) related to the received IO sequence, a QoS related to the previously received IO sequence, and their respective IO data types.

12. The apparatus of claim 11, wherein the QoS corresponds to one or more of each IO's service level and/or a performance capability of each IO's related storage track.

13. The apparatus of claim 11, wherein identifying the matching previously received IO sequence includes:
generate a unique fingerprint for the received IO stream; and
match the received IO stream's unique fingerprint to the previously received IO sequence's fingerprint, wherein matching fingerprints includes querying a searchable data structure that correlates one or more fingerprints with respective one or more previously received IO sequences.

14. The apparatus of claim 11, further configured to:
identify a storage track related to each IO of the received IO sequence; and
generate a fingerprint for the received IO sequence based on each identified storage track's address space.

15. The apparatus of claim 13, further configured to:
identify a QoS corresponding to each identified address space;
determine a QoS corresponding to each address space related to the previously received IO sequence; and
compare each QoS related to the received IO sequence with each QoS related to the previously received IO sequence.

16. The apparatus of claim 14, further configured to:
determine all possible QoS relationships resulting from the comparison; and
establish one or more data dedupe policies based on each possible QoS relationship.

17. The apparatus of claim 11, further configured to:
predict one or more IO workloads the storage array is expected to receive; and
establish the one or more data dedupe policies based on the possible QoS relationships and/or at least one characteristic related to the one or more predicted IO workloads.

18. The apparatus of claim 14, further configured to:
establish a QoS matching data dedupe policy based on the received IO sequence and the previously received IO sequence having a matching QoS relationship, wherein the matching QoS relationship indicates that the storage tracks related to the received IO sequence and the previously received IO sequence have substantially similar performance capabilities; and
establish a QoS mismatch data dedupe policy based on the received IO sequence and the previously received IO sequence having a mismatched QoS relationship, wherein the mismatched QoS relationship indicates that the storage tracks related to the received IO sequence have higher or lower performance capabilities than the storage tracks related to the previously received IO sequence.

19. The apparatus of claim 18, further configured to establish a QoS mixed data dedupe policy based on the received IO sequence and the previously received IO sequence having respective IOs with matching and mismatched QoS relationships.

20. The apparatus of claim 19, further configured to:
establish each of the QoS matching data dedupe policy, QOS mismatch data dedupe policy, and QoS mixed data dedupe policy-based further on one or more of:
a QoS device identifier associated with each storage track's related storage device,
a QoS group identifier associated with each storage track's related storage group, and/or
a threshold associated with the related storage devices and/or storage groups.
